(19) United States
(12) Patent Application Publication
(10) Pub. No.: US 2012/0014149 A1
(43) Pub. Date: Jan. 19, 2012

(54) POWER CONVERSION APPARATUS AND METHOD

(75) Inventor: Yutaka USAMI, Izunokuni-shi (JP)

(73) Assignee: Toshiba Tec Kabushiki Kaisha, Tokyo (JP)

(21) Appl. No.: 13/181,393

(22) Filed: Jul. 12, 2011

(30) Foreign Application Priority Data
Jul. 14, 2010 (JP) 2010-160008

(51) Int. Cl. H02M 7/04

(52) U.S. Cl. 363/84

(57) ABSTRACT

According to one embodiment a power conversion apparatus includes a first switch, a second switch, and a pulse generator. The first switch is connected at both ends of an AC power supply through an inductor and capacitor connected in series. The second switch is connected at both ends of the first switch through a smoothing capacitor connected in series. The pulse generator generates a first pulse signal for driving the first switch at a frequency higher than a cycle of the AC voltage, and supplies it to the first switch, when the polarity of the voltage of the AC power supply is positive. The pulse generator generates a second pulse signal for driving the second switch at a frequency higher than a cycle of the AC voltage, and supplies it to the second switch, when the polarity of the voltage of the AC power supply is negative.

### CROSS-REFERENCE TO RELATED APPLICATIONS

This application is based upon and claims the benefit of priority from prior Japanese Patent Application No. 2010-160008, filed on Jul. 14, 2010, the entire contents of which are incorporated herein by reference.

### FIELD

Embodiments described herein relate generally to a power conversion apparatus, which converts AC voltage supplied from an AC power supply to DC voltage, and supplies power to a load.

### BACKGROUND

There are two methods of converting an AC voltage to a DC voltage. A first method uses a diode bridge circuit and a smoothing capacitor. A diode bridge circuit performs full-wave rectification of an alternating current supplied from an AC power supply. A smoothing capacitor smoothes a direct current after full-wave rectification.

In a first method, a current always flows through a series circuit comprising two diodes in either case where an AC voltage is positive or negative. At this time, a power loss equivalent to the product of a current flowing through each diode and a forward voltage of a diode occurs in two diodes.

In a second method, a power factor converter (PFC) is used between a diode bridge circuit and a smoothing capacitor in the first method. A power factor converter increases the voltage of a direct current after full-wave rectification by a diode bridge circuit.

In the second method, a current flows in a series circuit comprising two diodes during full-wave rectification, and a power loss occurs. In addition, a current flows alternately in a field-effect transistor (FET) and diode comprising a power rector converter, causing additional loss.

Further, in a power factor converter, an output voltage must be set higher than an input voltage to obtain a sinusoidal waveform of an input current. However, a voltage required by a load is not necessarily higher than an input voltage. In such a case, a step-down converter is connected to a later stage of a power factor converter, thereby decreasing the voltage increased by a power factor converter to a desired value. A loss occurs while decreasing the voltage. As a whole unit, a power conversion apparatus comprises three stages of an AC-DC converter, a DC-DC (step-up) converter, and a DC-DC (step-down) converter. A power loss appears as a product of three stages. For example, assuming the efficiency of one stage to be 0.95, 0.95×0.95×0.95=0.86 for three stages. In other words, even if the conversion efficiency is as high as 95%, the efficiency decreases to 86% in three stages. As seen above, even if the conversion efficiency of each stage is high, the conversion efficiency extremely decreases in multiple stages.

Nowadays, energy-saving electronic apparatuses are being demanded. As a measure of saving energy, it is required to improve the conversion efficiency of a power conversion apparatus for supplying power to a load. However, the improvement of conversion efficiency is limited in a conventional circuit configuration.

### BRIEF DESCRIPTION OF THE DRAWINGS

FIG. 1 is a circuit diagram showing a power conversion apparatus of a first embodiment;

FIG. 2 is a waveform chart showing the relationship between an AC voltage and first and second pulse signals in the first embodiment;

FIG. 3 is a timing chart showing the operation of the power conversion apparatus in the first embodiment;

FIG. 4 is a graph showing output voltage waveforms when switching is executed and when switch is not executed in the first embodiment;

FIG. 5 is a circuit diagram showing a power conversion apparatus of a second embodiment;

FIG. 6 is a circuit diagram showing a power conversion apparatus of a third embodiment;

FIG. 7 is a circuit diagram showing a power conversion apparatus of a fourth embodiment;

FIG. 8 is a circuit diagram showing a power conversion apparatus of a fifth embodiment;

FIG. 9 is a chart showing the timing of operating a power conversion apparatus when the polarity of AC voltage is positive, in the fifth embodiment;

FIG. 10 is a chart showing the timing of operating a power conversion apparatus when the polarity of AC voltage is negative, in the fifth embodiment;

FIG. 11 is a circuit diagram showing a power conversion apparatus of a sixth embodiment;

FIG. 12 is a timing chart showing an output of a latch circuit in the sixth embodiment;

FIG. 13 is a timing chart showing the relationship between a voltage waveform and a current waveform in the sixth embodiment;

FIG. 14 is a circuit diagram showing a power conversion apparatus of a seventh embodiment;

FIG. 15 is a chart showing the timing of operating a power conversion apparatus when the polarity of AC voltage is positive, in the seventh embodiment;

FIG. 16 is a chart showing the timing of operating a power conversion apparatus when the polarity of AC voltage is negative, in the seventh embodiment;

FIG. 17 is a circuit diagram showing a first modification related to a current detector;

FIG. 18 is a circuit diagram showing a second modification related to a current detector;

FIG. 19 is a circuit diagram showing a third modification related to a current detector;

FIG. 20 is a circuit diagram showing a fourth modification related to a current detector; and

FIG. 21 is a waveform chart showing a voltage change at startup when 100V and 200V AC power are applied.

### DETAILED DESCRIPTION

In general, according to one embodiment a power conversion apparatus includes a first switch, a second switch, and a pulse generator. The first switch is connected at both ends of an AC power supply through an inductor and capacitor connected in series. The second switch is connected at both ends of the first switch through a smoothing capacitor connected in series. The pulse generator generates a first pulse signal for driving the first switch at a frequency higher than a cycle of the AC voltage, and supplies it to the first switch, when the polarity of the voltage of the AC power supply is positive. The pulse generator generates a second pulse signal for driving the second switch at a frequency higher than a cycle of the AC voltage, and supplies it to the second switch, when the polarity of the voltage of the AC power supply is negative.

Hereinafter, embodiments of a power conversion apparatus, which uses utility power of 100V (50/60 Hz) as an AC power supply, converts it to a desired DC voltage, and supplies power to a load will be explained with reference the accompanying drawings.

### First Embodiment

A first embodiment is explained with reference to FIGS. 1 to 4. FIG. 1 is a circuit diagram showing a power conversion apparatus 100 of a first embodiment.

In the power conversion apparatus 100, a first semiconductor switch Q1 is connected at both ends of an AC power supply 101 through an inductor L1 and capacitor C1 connected in series. The switch Q1 uses an N-channel MOSFET. Specifically, one end of the capacitor C1 is connected to one end of the AC power supply 101 through an inductor L1. A drain terminal of the MOSFET is connected to the other end of the capacitor C1. A source terminal of the MOSFET is connected to the other end of the AC power supply 101.

In the power conversion apparatus 100, a second semiconductor switch Q2 is connected at both ends of the first semiconductor switch Q1 through a smoothing capacitor C2 connected in series. The switch Q2 uses an N-channel MOSFET. Specifically, a source terminal of the MOSFET is connected to a point connecting the capacitor C1 and switch Q1. A drain terminal of the MOSFET is connected to a positive-electrode terminal of the smoothing capacitor C2. A negative terminal of the smoothing capacitor C2 is connected to a point connecting the AC power supply 101 and switch Q1.

In the power conversion apparatus 100, both ends of the smoothing capacitor C2 are output terminals 102 and 103. A desired load L is connected between the output terminals 102 and 103.

In the power conversion apparatus 100, a polarity determinator 104 is connected at both ends of the AC power supply 101. A polarity determinator 104 determines the polarity (positive or negative) of the AC voltage Va obtained from the AC power supply 101. In the power conversion apparatus 100, information about the polarity determined by the polarity determinator 104 is sent to a pulse generator 105.

The polarity determinator 104 outputs data of logical “1” to the pulse generator 105 when the polarity of the AC voltage Va is positive, and outputs data of logical “0” to the pulse generator 105 when the polarity is negative. In other words, the polarity determinator 104 applies a voltage of 5V to the pulse generator 105 when the polarity of the AC voltage Va is positive, and applies a voltage of 0V to the pulse generator 105 when the polarity is negative.

The pulse generator 105 generates a first pulse signal P1 when the output from the polarity determinator 104 is positive, and generates a second pulse signal P2 when the output is negative.

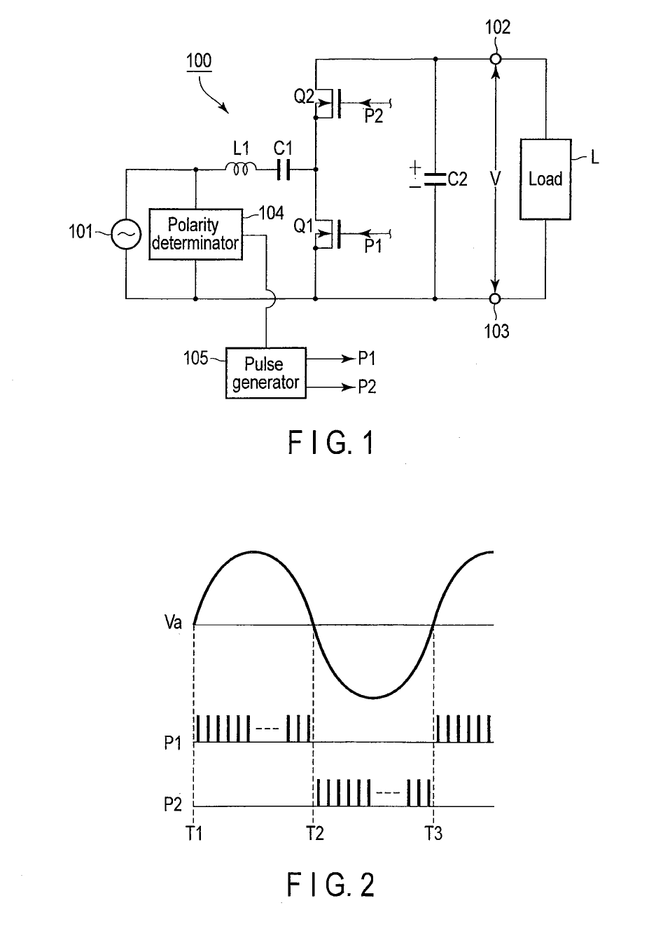

FIG. 2 is a waveform chart showing the relationship between the AC voltage Va and the first and second pulse signals P1 and P2. In FIG. 2, the polarity of the AC voltage Va is positive in sections T1 to T2. In these sections, the pulse generator 105 generates a first pulse signal P1 at a frequency far higher than a cycle of the AC voltage Va.

In FIG. 2, the polarity of the AC voltage Va is negative in sections T2 to T3. In these sections, the pulse generator 105 generates a second pulse signal P2 at a frequency far higher than a cycle of the AC voltage Va.

In the power conversion apparatus 100, a first pulse signal P1 is supplied to the first switch Q1, and a second pulse signal P2 is supplied to the second switch Q2. The first switch Q1 conducts each time the second pulse signal P2 is supplied.

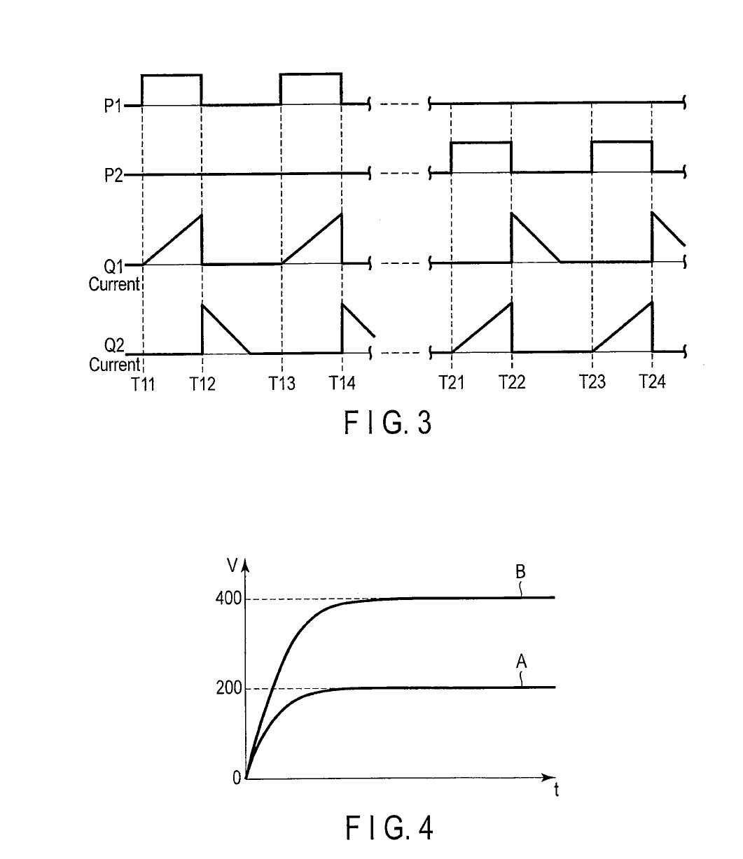

The operation of the power conversion apparatus 100 by the first and second pulse signals P1 and P2 is explained by referring to the timing chart of FIG. 3.

FIG. 3 shows the first and second pulse signals P1 and P2, and a current flowing through the first and second switches Q1 and Q2.

First, the operation when the polarity of the AC voltage Va is positive is explained. When the polarity of the AC voltage Va is positive, the first pulse signal P1 is periodically generated. When the first pulse signal P1 turns on (at the timing T11 and T13 in FIG. 3), the first switch Q1 conducts. When the first switch Q1 conducts, a closed circuit comprising an AC power supply 101, an inductor L1, a capacitor C1, and a first switch Q1 is formed. As a result, a current flows from the capacitor C1 to the first switch Q1 by the linear action of a reactor of the inductor L1 (in the sections T11-T12 and T13-T14 in FIG. 3).

When the first pulse signal P1 turns off (at the timings T12 and T14 in FIG. 3), the first switch Q1 becomes nonconductive. When the first switch Q1 becomes nonconductive, the current flowing through the first switch Q1 becomes zero. At this time, the inductor L1 tends to flow a current in the same direction by the energy of a reactor. Consequently, a current flows into the smoothing capacitor C2 through a body diode of the second switch Q2 (in the sections T12-T13 in FIG. 3).

Each time the first pulse signal P1 is output, the power conversion apparatus 100 repeats the above operation. As a result, the power conversion apparatus 100 charges the smoothing capacitor C2, while increasing the voltage V across the output terminals 102 and 103.

Next, the operation when the polarity of the AC voltage Va is negative is explained. When the polarity of the AC voltage Va is negative, the second pulse signal P2 is periodically generated. When the second pulse signal P2 turns on (at the timing T21 and T23 in FIG. 3), the second switch Q2 conducts. When the second switch Q2 conducts, a closed circuit comprising an AC power supply 101, an inductor L1, a capacitor C1, a second switch Q2, and a smoothing capacitor C2 is formed. At this time, the voltage of the smoothing capacitor C2 is higher than the AC voltage Va. As a result, the power conversion apparatus 100 is operated so that the charging voltage of the smoothing capacitor C2 returns to the AC power supply 101 through the second switch Q2 and inductor L1. Therefore, a current flows from the capacitor C2 to the second switch Q2 (in the sections T21-T22 and T23-T24 in FIG. 3).

When the second pulse signal P2 turns off (at the timings T22 and T24 in FIG. 3), the second switch Q2 becomes nonconductive. When the second switch Q2 becomes nonconductive, the current flowing through the second switch Q2 becomes zero. At this time, the inductor L1 tends to flow a current in the same direction by the energy of a reactor. Consequently, a current flows into the capacitor C1 through a body diode of the first switch Q1 (in the sections T22-T23 in FIG. 3).

Each time the second pulse signal P2 is output, the power conversion apparatus 100 repeats the above operation. As a result, the power conversion apparatus 100 recharges the capacitor C1.

The polarity of the AC voltage Va is alternately changed to positive and negative. Therefore, the power conversion apparatus 100 alternately repeats charging the smoothing capacitor C2 and recharging the capacitor C1. In other words, the power conversion apparatus 100 charges the smoothing capacitor C2 after recharging the capacitor C1. Therefore, when the smoothing capacitor C2 is charged, the electric charge stored in the capacitor C1 is moved to the smoothing capacitor C2.

If the first and second switch Q1 and Q2 do not operate, the circuit of the power conversion apparatus 100 shown in FIG. 1 functions as a voltage doubler circuit. In other words, when the input voltage is AC 100V for example, a DC voltage of about 200V is generated across the output terminals 102 and 103 as indicated by the voltage waveform A in FIG. 4.

As described above, when the first and second switch Q1 and Q2 operate, the electric charge stored in the capacitor C1 is moved to the smoothing capacitor C2. Therefore, the pressor effect of the power conversion apparatus 100 is added. As a result, the power conversion apparatus 100 increases the input AC voltage Va to a value higher than the value double the input voltage, and obtains a DC output voltage V.

The output voltage V can be controlled by the pulse widths of the first and second pulse signals P1 and P2. In other words, the output voltage V increases when the pulse width is extended, and decreases when the pulse width is reduced. Depending on the setting of the pulse widths of the first and second pulse signals P1 and P2, the power conversion apparatus 100 can obtain a voltage of about 400V DC from the input voltage of 100V AC across the output terminals 102 and 103, as indicated by the voltage waveform B in FIG. 4.

As described above, according to the first embodiment, the power conversion apparatus 100 can supply power to the load L by converting the AC voltage obtained from the AC power supply 101 to a DC voltage without full-wave rectification. Since a diode bridge circuit for full-wave rectification is unnecessary, the number of circuit components is reduced, and the cost is reduced. Further, a loss caused by a forward voltage generated in a diode bridge is eliminated, and efficient power conversion is realized by the power conversion apparatus 100.

### Second Embodiment

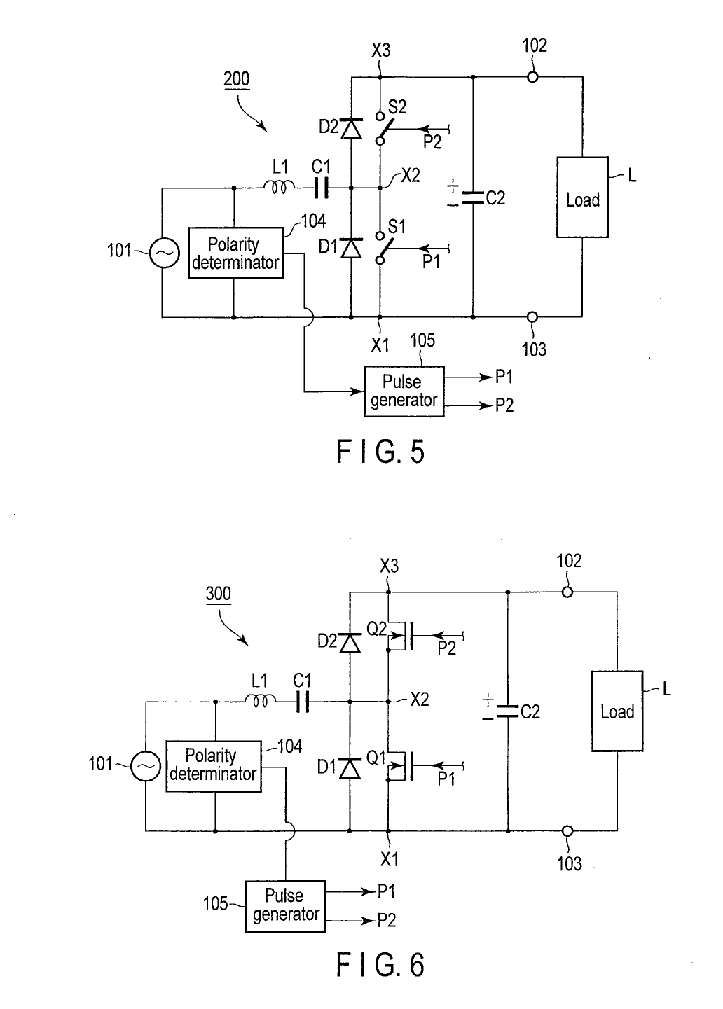

A second embodiment is explained with reference to FIG. 5. FIG. 5 is a circuit diagram showing a power conversion apparatus 200 of a second embodiment. The parts common to those in FIG. 1 are given the same reference numbers, and a detailed explanation is therefore omitted.

In the first embodiment, the semiconductor switches Q1 and Q2 are used as a pair of switches operated by the first and second pulse signals P1 and P2. In the second embodiment, mechanical switches S1 and S2 are used instead of semiconductor switches.

In the power conversion apparatus 200, a first mechanical switch S1 is connected at both ends of an AC power supply 101 through an inductor L1 and capacitor C1 connected in series. A second mechanical switch S2 is connected at both ends of the switch S1 through a smoothing capacitor C2 connected in series.

In the power conversion apparatus 200, a first external diode D1 is connected in parallel to the first switch S1. Specifically, an anode of a first diode D1 is connected to a point X1 connecting the first switch S1 and AC power supply 101, and a cathode of the first diode D1 is connected to a point X2 connecting the first switch S1 and capacitor C1.

In the power conversion apparatus 200, a second external diode D2 is connected in parallel to a second switch S2. Specifically, an anode of a second diode D2 is connected to a point X2 connecting the second switch S2 and capacitor C1, and a cathode of the second external diode D2 is connected to a point X3 connecting the second switch S2 and smoothing capacitor C2.

The other configurations are the same as those of the power conversion apparatus 100 of the first embodiment. Therefore, when the polarity of the AC voltage Va is positive, the first switch S1 alternately becomes conductive and nonconductive at a frequency far higher than a cycle of AC voltage Va. When the first switch S1 conducts, a closed circuit comprising an AC power supply 101, an inductor L1, a capacitor C1 and a first switch S1 is formed. As a result, a current flows from the capacitor C1 to the first switch S1 by the linear action of a reactor of the inductor L1.

When the first switch S1 becomes nonconductive, the current flowing through the first switch S1 becomes zero. At this time, the inductor L1 tends to flow a current in the same direction by the energy of a reactor. Consequently, a current flows into the smoothing capacitor C2 through the second external diode D2.

When the polarity of the AC voltage Va is negative, the second switch S2 alternately becomes conductive and nonconductive at a frequency far higher than a cycle of AC voltage Va. When the second switch S2 conducts, a closed circuit comprising an AC power supply 101, a inductor L1, a capacitor C1, a second switch S2, and a smoothing capacitor C2 is formed. At this time, the voltage of the smoothing capacitor C2 is higher than the AC voltage Va. As a result, the power conversion apparatus 200 operates so that the charging voltage of the smoothing capacitor C2 returns to the AC power supply 101 through the second switch S2 and inductor L1. Consequently, a current flows from the smoothing capacitor C2 to the second switch S2.

When the second switch S2 becomes nonconductive, the current flowing through the second switch S2 becomes zero. At this time, the inductor L1 tends to flow a current in the same direction by the energy of a reactor. Consequently, a current flows into the capacitor C1 through the first diode D1.

As described above, the power conversion apparatus 200 uses external diodes D1 and D2 instead of a body diode used in a MOSFET. The diodes D1 and D2 must have a voltage lower than a forward voltage of the body diode. As a result, the power conversion apparatus 200 provides a higher effect of decreasing the loss caused by a forward voltage of the diode than the power conversion apparatus 100 of the first embodiment.

### Third Embodiment

A third embodiment is explained with reference to FIG. 6. FIG. 6 is a circuit diagram showing a power conversion apparatus 300 of a third embodiment. The parts common to those in FIGS. 1 and 5 are given the same reference numbers, and a detailed explanation is therefore omitted.

In the second embodiment, mechanical switches S1 and S2 are used as a pair of switches. In the third embodiment, semiconductor switches Q1 and Q2 are used as in the first embodiment. In other words, in the power conversion apparatus 300, a first external diode D1 is connected in parallel to a first semiconductor switch Q1, and a second external diode D2 is connected in parallel to a second semiconductor switch Q2.

The first diode D1 has a forward voltage lower than that of a body diode of the first semiconductor switch Q1. Likewise, the second diode D2 has a forward voltage lower than that of a body diode of the second semiconductor switch Q2.

The current, which flows through the body diode of the first or second semiconductor switch Q1 or Q2 in the power conversion apparatus 100 of the first embodiment, flows through the first or second external diodes D1 or D2 in the power conversion apparatus 300 of the third embodiment. Therefore, the power conversion apparatus 300 provides a higher effect of decreasing the loss caused by a forward voltage of a diode greater than the power conversion apparatus 100.

If the semiconductor switches Q1 and Q2 are used as a switch, since the semiconductor switches Q1 and Q2 have a body diode, the external diodes D1 and D2 are theoretically unnecessary. However, generally, a body diode has a high forward voltage (1.2V), and the efficiency is increased by the difference of forward voltage by providing an external diode whose forward voltage is lower than a body diode, for example, 0.8V.

### Fourth Embodiment

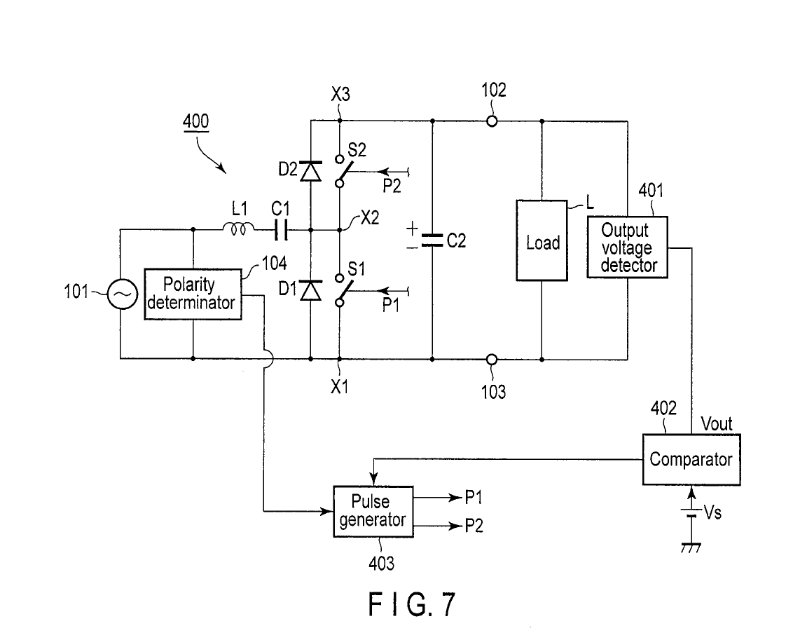

A fourth embodiment is explained with reference to FIG. 7. FIG. 7 is a circuit diagram showing a power conversion apparatus 400 of a fourth embodiment. The parts common to those in FIG. 5 are given the same reference numbers, and a detailed explanation is therefore omitted.

In the power conversion apparatus 400, the circuit configuration of an AC power supply 101 to output terminals 102 and 103 is the same as in the power conversion apparatus 200 of the second embodiment. In the power conversion apparatus 400, an output voltage detector 401 is connected between the output terminals 102 and 103. The output voltage detector 401 detects a voltage Vout across the output terminals 102 and 103, which are both ends of a smoothing capacitor C2, and outputs a detected signal to a comparator 402.

The comparator 402 compares the output voltage Vout detected by the output voltage detector 401 with a preset reference voltage Vs. When the output voltage Vout is greater than the reference voltage Vs, the comparator 402 sends information indicating that the output voltage is high, for example, logical “1”, to a pulse generator 403. On the other hand, when the output voltage Vout is lower than the reference voltage Vs, comparator 402 sends information indicating that the output voltage is low, for example, logical “0”, to a pulse generator 403.

Like the pulse generator 105 of the first to third embodiment, the pulse generator 403 generates a first pulse signal P1 when the output from the polarity determinator 104 is positive, and generates a second pulse signal P2 when the output is negative. However, in the fourth embodiment, the pulse generator 403 changes the pulse widths of the pulse signal P1 and P2 according to the information from the comparator 402 indicating that the output voltage is high or low. Specifically, the pulse generator 403 extends the pulse width when the output voltage is low, and reduces the pulse width when the output voltage is high.

In the power conversion apparatus 400 configured as described above, when the output voltage Vout is lower than the reference voltage Vs, the pulse widths of the first and second pulse signals P1 and P2 are extended. Therefore, the time that the mechanical switches S1 and S2 conduct is increased. As a result, the amount of current flowing through the mechanical switches S1 and S2 is increased, and the output voltage Vout is increased.

Contrarily, when the output voltage Vout is greater than the predetermined reference voltage Vs, the pulse widths of the first and second pulse signals S1 and S2 are reduced. Therefore, the time that the mechanical switches S1 and S2 conduct is reduced. As a result, the amount of current flowing through the mechanical switches S1 and S2 is decreased, and the output voltage Vout is decreased. As described above, the power conversion apparatus 400 can keep the output voltage Vout very close to the reference voltage Vs by feedback control of the output voltage Vout.

### Fifth Embodiment

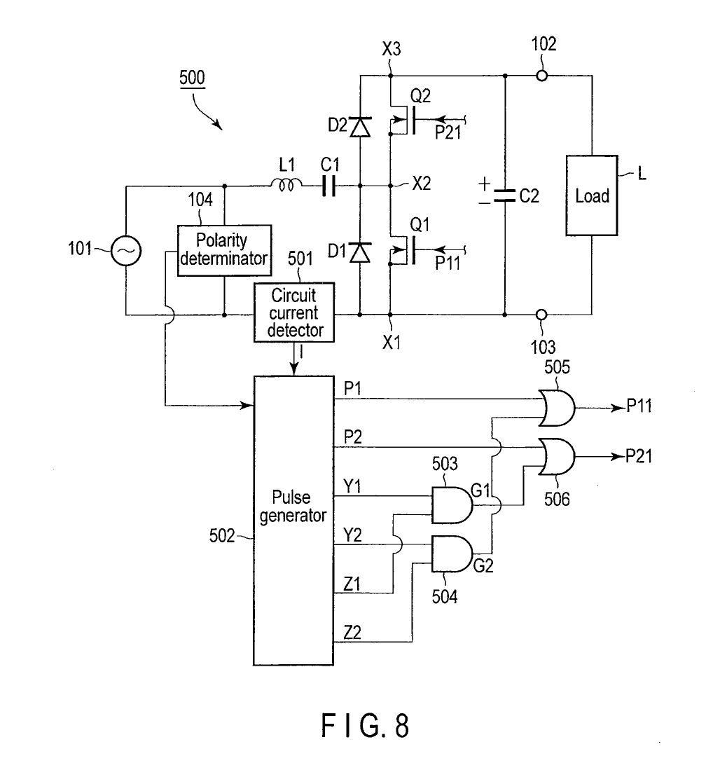

A fifth embodiment is explained with reference to FIGS. 8 to 10. FIG. 8 is a circuit diagram showing a power conversion apparatus 500 of a fifth embodiment. The parts common to those in FIG. 6 are given the same reference numbers, and a detailed explanation is therefore omitted.

In the power conversion apparatus 500, the circuit configuration of an AC power supply 101 to output terminals 102 and 103 is the same as in the power conversion apparatus 300 of the third embodiment. In the power conversion apparatus 500, a circuit current detector 501 is connected between an AC power supply 101 and a point X1 connecting a first semiconductor switch Q1 and a first external diode D1. The circuit current detector 501 detects a circuit current I flowing through the AC power supply 101, and sends the detected signal to a pulse generator 502.

Like the pulse generator 105 of the second embodiment, the pulse generator 502 outputs a first pulse signal P1 when the output from the polarity determinator 104 is positive, and outputs a second pulse signal P2 when the output is negative. Further, the pulse generator 502 outputs first and second delay pulse signals Y1 and Y2, and first and second zero-margin pulse signals Z1 and Z2.

The first delay pulse signal Y1 turns on when minute delay time d elapses after the first pulse signal P1 turns off, and turns off when the next first pulse signal P1 turns on. The second delay pulse signal Y2 turns on when minute delay time d elapses after the second pulse signal P2 turns off, and turns off when the next second pulse signal P2 turns on.

The zero-margin signal Z1 turns on at the timing that the first pulse signal P1 turns on, and turns off immediately before a circuit current I becomes zero after the first pulse signal P1 turns off. The second zero-margin signal Z1 turns on at the timing that the second pulse signal P2 turns on, and turns off immediately before the circuit current I becomes zero after the second pulse signal P2 turns off. The pulse generator 502 determines whether the circuit current I is very close to becoming zero, based on the value of the circuit current I supplied from the circuit current detector 501, and controls the timing to turn off the first and second zero-margin pulse signals Z1 and Z2.

The power conversion apparatus 500 comprises a first AND gate 503, a second AND gate 504, a first OR gate 505, and a second OR gate 506. The first AND gate 503 calculates a logical product of the first delay pulse signal Y1 and first zero-margin pulse signal Z1. The second AND gate 504 calculates a logical product of the second delay pulse signal Y2 and second zero-margin pulse signal Z2. The first OR gate 505 calculates a logical sum of the first pulse signal P1 and the second sub-pulse signal G2 that is a result of the logical product calculated by the second AND gate 504. The second OR gate 506 calculates a logical sum of the second pulse signal P2 and the first sub-pulse signal C1 that is a result of the logical product calculated by the first AND gate 503.

The power conversion apparatus 500 supplies the first switch Q1 with a pulse signal P11 that is a result of the logical sum calculated by the first OR gate 505. The power conversion apparatus 500 supplies the second switch Q2 with a pulse signal P21 that is a result of the logical sum calculated by the second OR gate 506. The first switch Q1 conducts while the pulse signal P11 is being supplied. The second switch Q2 conducts while the pulse signal P21 is being supplied.

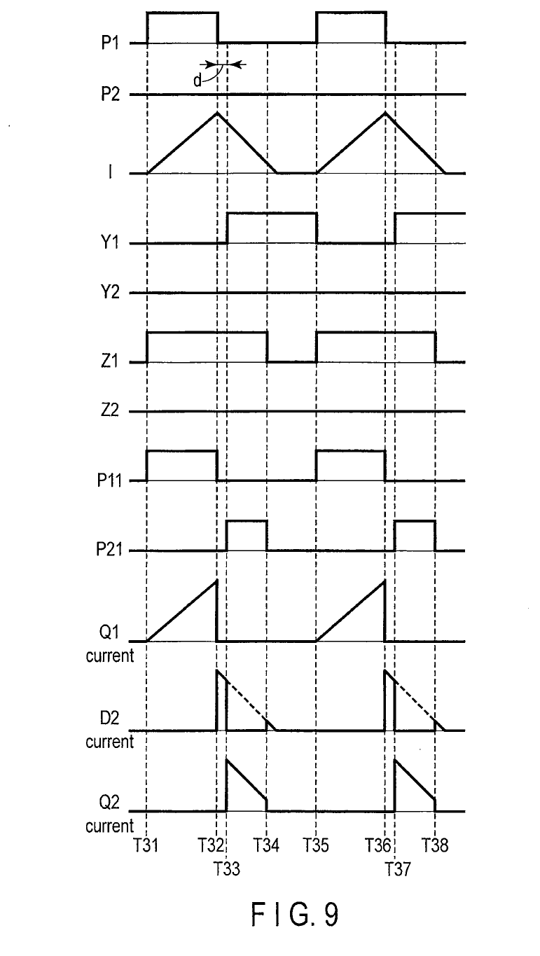

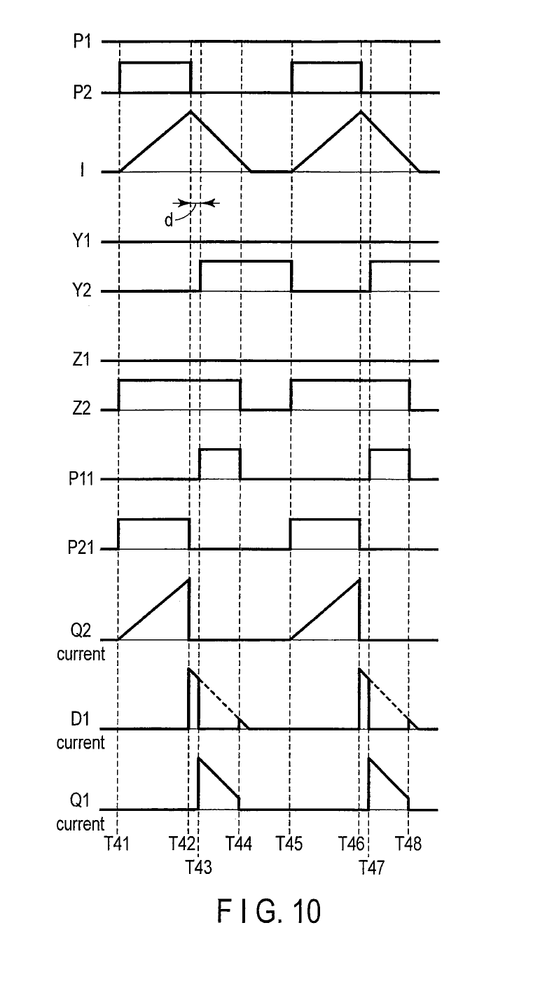

The operation of the power conversion apparatus 500 configured as described above is explained with reference to the timing charts of FIGS. 9 and 10.

FIG. 9 is a timing chart showing the operation of the power conversion apparatus 500 when the polarity of the AV voltage Va is positive. When the polarity of the AV voltage Va is positive, the pulse generator 502 periodically outputs a first pulse signal P1. When the first pulse signal P1 turns on (at the timing of T31 and T35 in FIG. 9), the pulse signal P11 output from the first OR gate 505 turns on, and the first switch Q1 conducts.

When the first switch Q1 conducts, a closed circuit comprising an AC power supply 101, an inductor L1, a capacitor C1, and a first switch Q1 is formed.

As a result, a current I flows from the capacitor C1 to the first switch Q1 by the linear action of a reactor of the inductor L1 (in the sections T31-T32 and T35-T36 in FIG. 9).

The pulse generator 502 turns on the first zero-margin pulse signal Z1 in synchronization with turning on of the first pulse signal P1 (at the timing T31 and T35 in FIG. 9). However, at this timing, the first delay pulse signal Y1 has turned off. Therefore, the first sub-pulse signal G1 output from the first AND gate 503 has also turned off. At this time, as the second pulse signal P2 has also turned off, the pulse signal P21 output from the second OR gate 506 is held off.

Further, the second delay pulse signal Y2 and second zero-margin pulse signal Z2 have also turned off. Therefore, the second sub-pulse signal G2 output from the second AND gate 504 has turned off. Thus, when the first pulse signal P1 turns off (at the timing T32 and T36 in FIG. 9), the pulse signal P11 output from the first OR gate 505 turns off. When the pulse signal P11 turns off, the first switch Q1 becomes nonconductive. When first switch 41 becomes nonconductive, the current flowing through the first switch Q1 becomes zero. At this time, the inductor L1 tends to flow a current in the same direction by the energy of a reactor. Consequently, a current flows into the smoothing capacitor C2 through the second diode D2.

When minute delay time d elapses after the first pulse signal P1 turns off (at the timing T33 and T37 in FIG. 9), the first delay pulse signal Y1 turns on. At this time, as the first zero-margin pulse signal Z1 has turned on, the first sub-pulse signal G1 output from the first AND gate 503 has turned on. As a result, the pulse signal P21 output from the second OR gate 506 turns on.

When the pulse signal P21 turns on, the second switch Q2 conducts. The turn-on resistance of the second switch Q2 is assumed to be sufficiently lower than that of the second diode D2. In this case, when the second switch Q2 conducts, the current flowing into the smoothing capacitor C2 through the second diode D2 flows into the smoothing capacitor C2 through the second switch Q2 (in the sections T33-T34 and T37-T38 in FIG. 9).

Thereafter, the first zero-margin pulse signal Z1 turns off at the timing immediately before the current flowing through the second switch Q2 becomes zero (at the timing T34 and T38 in FIG. 9). When the first zero-margin pulse signal Z1 turns off, the first sub-pulse signal G1 output from the first AND gate 503 turns off, and at the same time, the pulse signal P21 output from the second OR gate 506 turns off.

When the pulse signal P21 turns off, the second switch Q2 becomes nonconductive. When the second switch Q2 becomes nonconductive, the current flowing into the smoothing capacitor C2 through the second switch Q2 flows again into the smoothing capacitor C2 through the second diode D2.

FIG. 10 is a timing chart showing the operation of the power conversion apparatus 500 when the polarity of the AC voltage Va is negative. When the polarity of the AC voltage Va is negative, the pulse generator 502 periodically outputs a second pulse signal P2. When the second pulse signal P2 turns on (at the timing of T41 and T45 in FIG. 10), the pulse signal P21 output from the second OR gate 506 turns on, and the second switch Q2 conducts.

When the second switch Q2 conducts, a closed circuit comprising an AC power supply 101, an inductor L1, a capacitor C1, a second switch Q2, and a smoothing capacitor C2 is formed. At this time, the voltage of the smoothing capacitor C2 is higher than the AC voltage Va. As a result, the power conversion apparatus 500 operates so that the charging voltage of the smoothing capacitor C2 returns to the AC power supply 101 through the second switch Q2 and inductor L1. Consequently, a current flows from the smoothing capacitor C2 to the second switch Q2 (in the sections T41-T42 and T45-T46 in FIG. 10).

The pulse generator 502 turns on second first zero-margin pulse signal Z2 in synchronization with turning on of the second pulse signal P2 (at the timing T41 and T45 in FIG. 10). However, at this timing, the second delay pulse signal Y2 has turned off. Therefore, the second sub-pulse signal G2 output from the second AND gate 504 has also turned off. At this time, as the first pulse signal P1 has also turned off, the pulse signal P11 output from the first OR gate 505 is held off.

Further, the first delay pulse signal Y1 and first zero-margin pulse signal Z1 have also turned off. Therefore, the first sub-pulse signal G1 output from the first AND gate 503 has turned off. Thus, when the second pulse signal P2 turns off (at the timing T42 and T46 in FIG. 10), the pulse signal P21 output from the second OR gate 506 turns off.

When the pulse signal P21 turns off, the second semiconductor switch Q2 becomes nonconductive. When second semiconductor switch Q2 becomes nonconductive, the current flowing through the second switch Q2 becomes zero. At this time, the inductor L1 tends to flow a current in the same direction by the energy of a reactor. Consequently, a current flows into the capacitor C1 through the first diode D1.

When minute delay time d elapses after the second pulse signal P2 turns off (at the timing T43 and T47 in FIG. 10), the second delay pulse signal Y2 turns on. At this time, as the second zero-margin pulse signal Z2 has turned on, the second sub-pulse signal G2 output from the second AND gate 504 turns on. As a result, the pulse signal P11 output from the first OR gate 505 turns on.

When the pulse signal P11 turns on, the first switch Q1 conducts. The turn-on resistance of the first switch Q1 is assumed to be sufficiently lower than that of the first diode D1. In this case, when the first switch Q1 conducts, the current flowing into the capacitor C1 through the first diode D1 flows into the capacitor C1 through the first switch Q1 (in the sections T43-T44 and T47-T48 in FIG. 10).

Thereafter, the second zero-margin pulse signal Z2 turns off at the timing immediately before the current flowing through the first switch Q1 becomes zero (at the timing T44 and T48 in FIG. 10). When the second zero-margin pulse signal Z2 turns off, the second sub-pulse signal G2 output from the second AND gate 504 turns off, and at the same time, the pulse signal P11 output from the first OR gate 505 turns off. When the pulse signal P11 turns off, the first switch Q1 becomes nonconductive. When the first switch Q1 becomes nonconductive, the current flowing into the capacitor C1 through the first switch Q1 flows again into the capacitor C1 through the first diode D1.

As described above, the current, which flows into the second diode D2 when the first switch Q1 turns off in the power conversion apparatus 300 of the third first embodiment., flows into the second switch Q2 when minute delay time d elapses after the timing that the first switch Q1 turns off in the power conversion apparatus 500 of the fifth embodiment.

The current flows again into the second diode D2 immediately before the current becomes zero. Similarly, the current, which flows into the first diode D1 when the second switch Q2 turns off, flows into the first switch Q1 after minute delay time d elapses from the timing that the second switch Q2 turns off.

The turn-on resistance of the first and second switches Q1 and Q2 is much lower than that of the diodes D1 and D2. Therefore, the power conversion apparatus 500 can increase the power conversion efficiency higher than the power conversion apparatus 300 of the third embodiment.

Further, the power conversion efficiency can be further increased by matching the timing to turn on/off the first and second switch Q1 and Q2.

However, the semiconductor switches Q1 and Q2 may simultaneously turn on due to the uneven characteristics. If the first and second semiconductor switches Q1 and Q2 simultaneously turn on, a through-current flows, and shorts the circuit.

To prevent such a defect, the power conversion apparatus 500 generates delay pulse signals Y1 and Y2 in the pulse generator 502. If the first switch Q1 turns off according to the output timing of the delay pulse signals Y1 and Y2, the second switch Q2 turns on after minute delay time d. Contrarily, if the second switch Q2 turns off, the first switch Q1 turns on after minute delay time d. Therefore, the first and second switches Q1 and Q2 do not simultaneously turn on in any section.

Further, in the power conversion apparatus 500, after the circuit current I becomes zero, a voltage is impressed in the direction to shut off the diodes D1 and D2. If the switches Q1 and Q2 conduct when the circuit current I is zero, the diodes D1 and D2 are not shut off, and the circuit gets out of order.

In the fifth embodiment, the pulse generator 502 generates zero-margin pulse signals Z1 and Z2. According to the output timing of the zero-margin pulse signals Z1 and Z2, the switches Q1 and Q2 become nonconductive immediately before the circuit current I becomes zero. Therefore, when the circuit current I becomes zero, the circuit is certainly shut off by the diodes D1 and D2, and the power conversion apparatus 500 never goes out of order.

### Sixth Embodiment

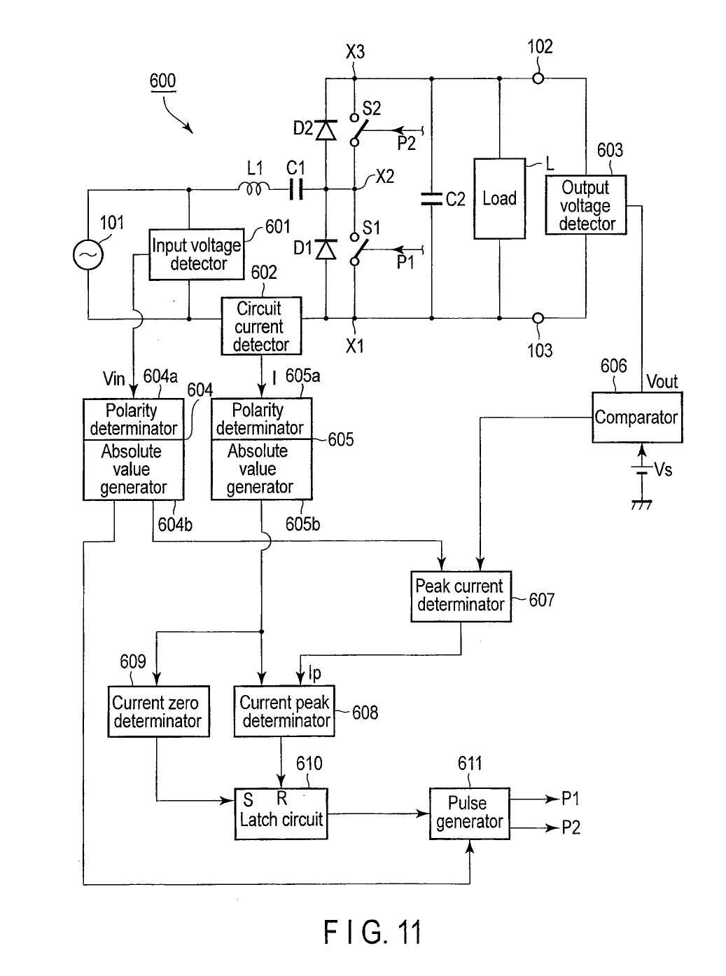

A sixth embodiment is explained with reference to FIGS. 11 to 13. FIG. 11 is a circuit diagram showing a power conversion apparatus 600 of a sixth embodiment. The parts common to those in FIG. 5 are given the same reference numbers, and a detailed explanation is therefore omitted.

In the power conversion apparatus 600, the circuit configuration of an AC power supply 101 to output terminals 102 and 103 is the same as in the power conversion apparatus 200 of the second embodiment. In the power conversion apparatus 600, an input voltage detector 601 is connected at both ends of the AC power supply 101. The input voltage detector 601 detects an input voltage Vin generated at both ends of the AC power supply 101, and sends the detected signal to a voltage signal processor 604.

In the power conversion apparatus 600, a circuit current detector 602 is connected between the AC power supply 101 and a point X1 connecting a first switch S1 and a first diode D1. The circuit current detector 602 detects a circuit current I flowing through the AC power supply 101, and sends the detected signal to a current signal processor 605.

In the power conversion apparatus 600, an output voltage detector 603 is connected between output terminals 102 and 103, which are both ends of a smoothing capacitor C2. The output voltage detector 603 detects an output voltage Vout generated across the output terminals 102 and 103, and sends the detected signal to a comparator 606.

The voltage signal processor 604 comprises a polarity determinator 604a and an absolute value generator 604b. The polarity determinator 604a determines a polarity (positive or negative) of the input voltage Vin. The absolute value generator 604b generates an absolute value of the input voltage Vin. The voltage signal processor 604 sends a polarity and absolute value of the input voltage Vin to a peak current determinator 607 and a pulse generator 611.

The current signal processor 605 comprises a polarity determinator 605a and an absolute value generator 605b. The polarity determinator 605a determines a polarity (direction) of the circuit current I. A current flowing from the AC power supply 101 to the point X1 is determined to be positive, and a current flowing in the reverse direction is determined to be negative. The absolute value generator 605b generates an absolute value of the circuit current I. The current signal processor 605 sends a polarity and absolute value of the circuit current I to a current peak determinator 608 and a current zero determinator 609.

The comparator 606 calculates the difference between the output voltage Vout detected by the output voltage detector 603 and the preset reference voltage Vs. The comparator 606 sends the calculated difference value between the output voltage Vout and reference voltage Vs to the peak current determinator 607. The difference value is positive when the output voltage Vout is lower than the reference voltage Vs, and negative when the output voltage Vout is higher than the reference voltage Vs.

The peak current determinator 607 multiplies the absolute value of the input voltage Vin sent from the voltage signal processor 604 by the voltage difference value sent from the comparator 606. The peak current determinator 607 sends the product to the current peak determinator 608.

The current peak determinator 608 recognizes the product sent from the peak current determinator 607 as a peak value Ip of the circuit current I. The current peak determinator 608 determines whether the value of the circuit current I sent from the current signal processor 605 reaches the peak value Ip. When the value of the circuit current I sent from the current signal processor 605 reaches the peak value Ip, the current peak determinator 608 sends a signal to a reset terminal R of a latch circuit 610.

The current zero determinator 609 determines whether the value of the circuit current I sent from the current signal processor 605 becomes zero. When the value of the circuit current I sent from the current signal processor 605 becomes zero, the current zero determinator 609 sends a signal to a set terminal S of the latch circuit 610. When a signal is sent to the set terminal S, the latch circuit 610 is set, and sends data of logical “1” to the pulse generator 611. When a signal is sent to the reset terminal R, the latch circuit 610 is reset, and sends data of logical “0” to the pulse generator 611.

The pulse generator 611 generates a first pulse signal P1 when the polarity of the signal sent from the voltage signal processor 604 is positive, and generates a second pulse signal when the polarity of the signal is negative. The pulse generator 611 sends a first pulse signal P1 to the first switch S1 while a state signal sent from the latch circuit 610 is logical “1”. Similarly, the pulse generator 611 sends a second pulse signal P2 to the second switch S2 while the state signal sent from the latch circuit 610 is logical “1”.

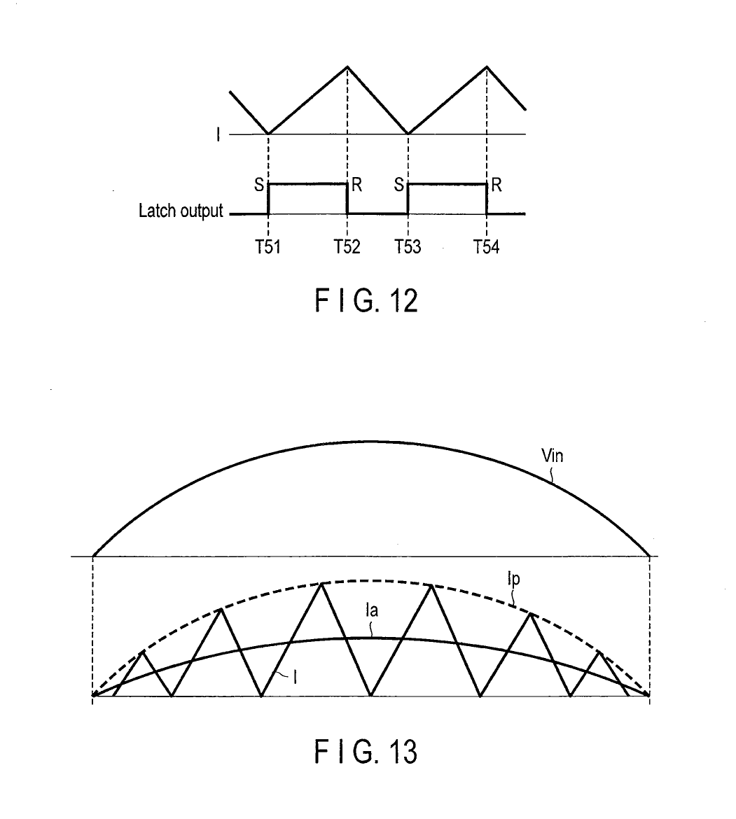

In the power conversion apparatus 600 configured as described above, when the circuit current I is determined to be zero by the current zero determinator 609 (at the timing T51 and T53 in FIG. 12), the output of the latch circuit 610 becomes logical “1”. When the circuit current I is determined to have reached the peak value IP by the current peak determinator 608 (at the timing T52 and T54 in FIG. 12), the output of the latch circuit 610 becomes logical “0”.

The peak value Ip is a product of the absolute value of the input voltage Vin from the voltage signal processor 604, voltage difference value from the comparator 606, and a predetermined coefficient. Therefore, the peak value IP is proportional to the input voltage V. As shown in FIG. 13, the envelope of the peak value Ip is sinusoidal, similar to the input voltage Vin. Further, when the output voltage Vout is lower than the reference voltage Vs, the envelope of the peak value IP is corrected to rise high as a whole. Similarly, when the output voltage Vout is higher than the reference voltage Vs, the envelope of the peak value IP is corrected to sink as a whole.

When the polarity of the AC voltage Va is positive, for example, the pulse generator 611 periodically outputs a first pulse signal P1 according to the output of the latch circuit 610. When the first pulse signal P1 turns on, the first switch S1 conducts.

When the first switch S1 conducts, a closed circuit comprising an AC power supply 101, an inductor L1, a capacitor C1, and a first switch S1 is formed. As a result, a current I flows from the capacitor C1 to the first switch S1 by the linear action of a reactor of the inductor L1.

When the circuit current I reaches a peak value Tp, the latch circuit 610 is reset. Consequently, the first pulse signal P1 turns off. When the first pulse signal P1 turns off, the first switch S1 becomes nonconductive, and the current flowing through the first switch S1 becomes .zero. At this time, the inductor L1 tends to flow a current in the same direction by the energy of a reactor. Therefore, a current flows into the smoothing capacitor C2 through the second diode D2.

When the polarity of the AC voltage Va is negative, the pulse generator 611 periodically outputs a second pulse signal P2 according to the output of the latch circuit 610. When the second pulse signal P2 turns on, the second switch S2 conducts.

When the second switch S2 conducts, a closed circuit comprising an AC power supply 101, an inductor L1, a capacitor C1, a second switch S2, and a smoothing capacitor C2 is formed. At this time, the voltage of the smoothing capacitor C2 is higher than the AC voltage Va. As a result, the power conversion apparatus 600 operates so that the charging voltage of the smoothing capacitor C2 returns to the AC power supply 101 through the second switch S2 and inductor L1. Consequently, a current flows from the capacitor C2 to the second switch S2.

When the circuit current I reaches a peak value Tp, the latch circuit 610 is reset. Consequently, the second pulse signal P2 turns off. When the second pulse signal P2 turns off, the second switch S2 becomes nonconductive, and the current flowing through the second switch S2 becomes zero. At this time, the inductor L1 tends to flow a current in the same direction by the energy of a reactor. Therefore, a current flows into the capacitor C1 through the first diode D1.

As described above, in the power conversion apparatus 600, the first or second switch S1 or S2 turn off so that the circuit current I does not exceed the peak value IP. The peak value IP draws an envelope curve. As the envelope is proportional to the input voltage Vin, the envelope curve is sinusoidal when the input voltage Vin is sinusoidal.

By turning off the first or second switch S1 or S2 repeatedly with the peak value Ip defined by the envelope curve, the circuit current I becomes triangular as shown in FIG. 13. An average value Ia of the circuit current I can be regarded as about ½ of the peak value Ip. In other words, the average current Ia appears sinusoidal as seen from the input side.

As described above, the power conversion apparatus 600 provides a sinusoidal input current waveform almost equal to an input voltage waveform. Therefore, a harmonic current never occurs in the input line, and a load on substation facilities can be reduced.

### Seventh Embodiment

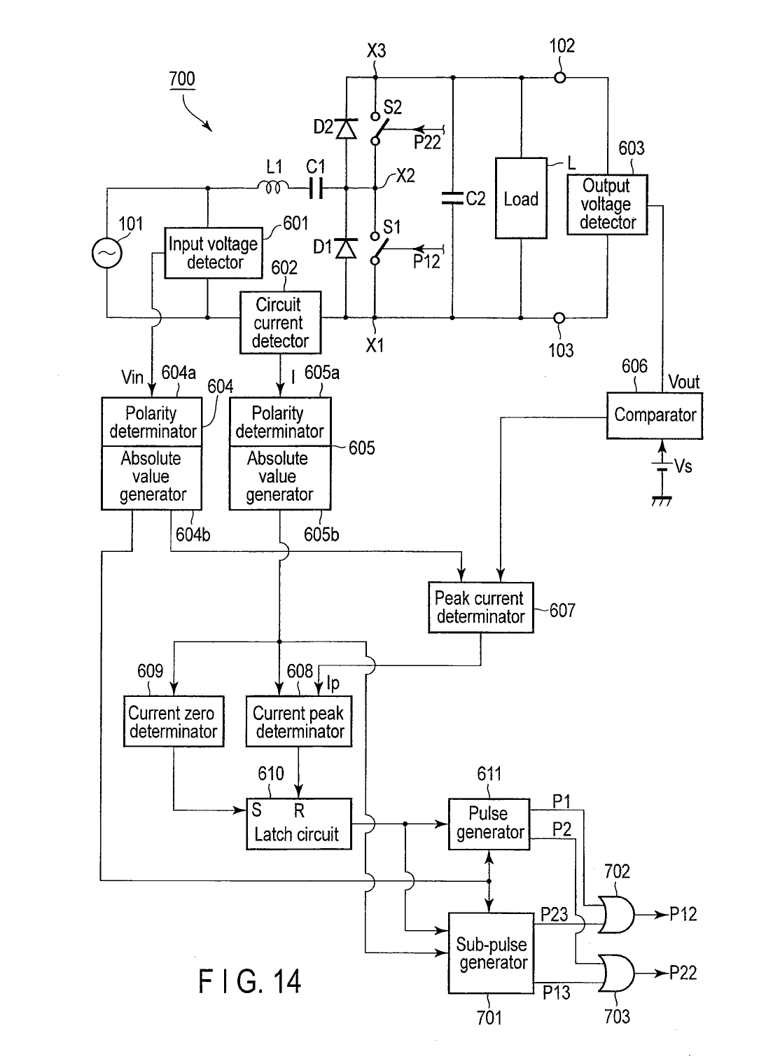

A seventh embodiment is explained with reference to FIGS. 14 to 16. FIG. 14 is a circuit diagram showing a power conversion apparatus 700 of a seventh embodiment. The parts common to those in FIG. 11 are given the same reference numbers, and a detailed explanation is therefore omitted.

The power conversion apparatus 700 is different from the power conversion apparatus 600 of the sixth embodiment in the point that a sub-pulse generator 701 and first and second OR gates 702 and 703 are added. The sub-pulse generator 701 is supplied with a polarity and absolute value of the input voltage Vin obtained from the voltage signal processor 604, a polarity and absolute value of the circuit current I obtained from the current signal processor 605, and a state of the latch circuit 610.

When the polarity of the input voltage Vin obtained from the voltage signal processor 604 is positive, the sub-pulse generator 701 outputs a first sub-pulse signal P13. The sub-pulse signal P13 turns off when minute delay time d elapses after the state signal supplied from the latch circuit 610 becomes logical “1”. Further, the first sub-pulse signal P13 turns off when the absolute value of the circuit current I obtained from the current signal processor 605 decreases to just before zero.

When the polarity of the input voltage Vin obtained from the voltage signal processor 604 is negative, the sub-pulse generator 701 outputs a second sub-pulse signal P23. The second sub-pulse signal P23 turns on when minute delay time d elapses after the state signal supplied from the latch circuit 610 becomes logical “1”. Further, the second sub-pulse signal P23 turns off when the absolute value of the circuit current I obtained from the current signal processor 605 decreases to just before zero.

The first OR gate 702 calculates a logical sum of the first pulse signal P1 supplied from the pulse generator 611 and the second pulse signal P23 supplied from the sub-pulse generator 701, and supplies a pulse signal 12 as a logical sum to the first switch S1. The first switch S1 conducts while the pulse signal P12 turns on.

The second OR gate 703 calculates a logical sum of the second pulse signal P2 supplied from the pulse generator 611 and the first pulse signal P13 supplied from the sub-pulse generator 701, and supplies a pulse signal 22 as a logical sum to the second switch S2. The second switch S2 conducts while the pulse signal P22 turns on.

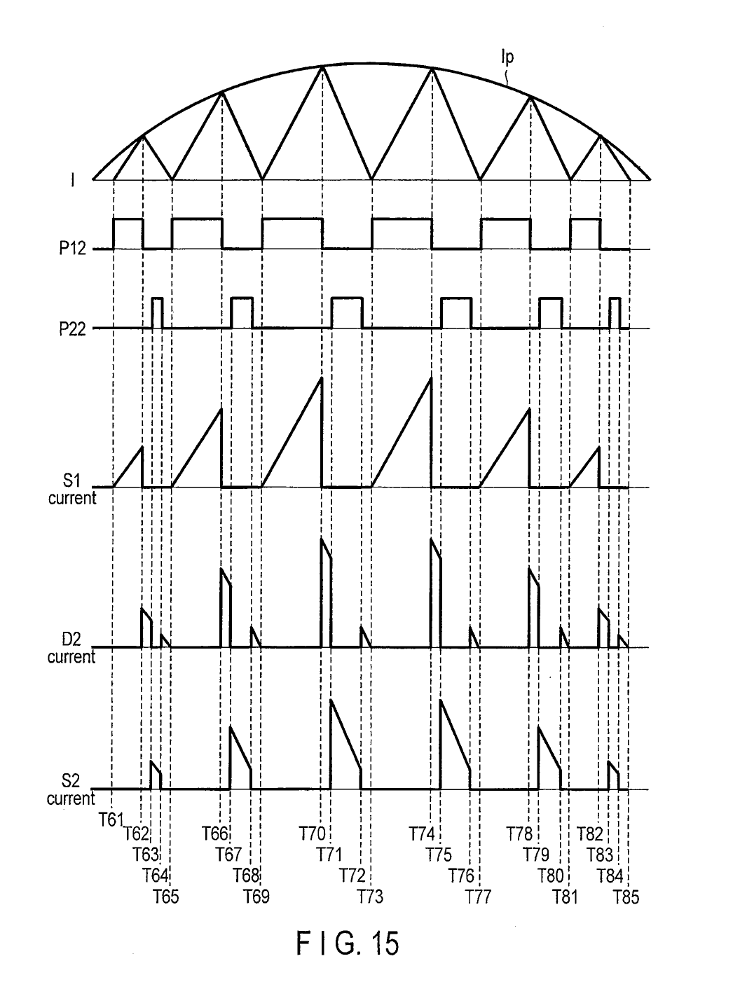

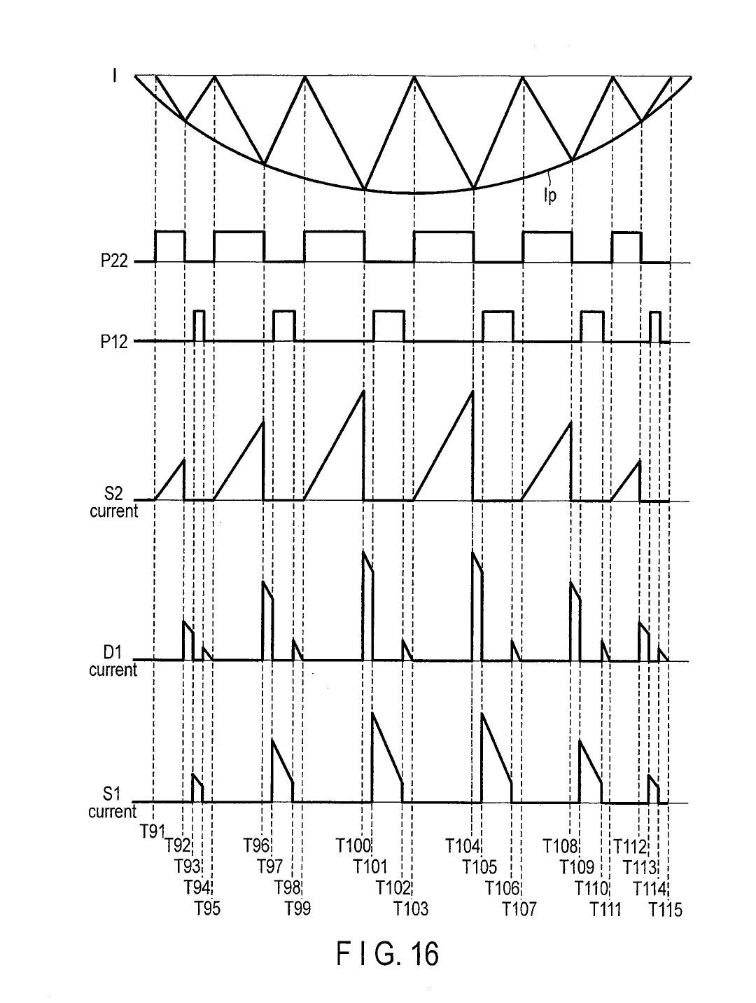

The operation of the power conversion apparatus 600 configured as described above is explained with reference to the timing charts of FIGS. 15 and 16. FIG. 15 is a timing chart showing the operation of the power conversion apparatus 600 when the polarity of the AC voltage Va is positive. As explained in the sixth embodiment, a peak current value Ip determined by the peak current determinator 607 draws a sinusoidal envelope curve.

When the polarity of the AC voltage Va is positive, the pulse generator 611 periodically outputs a first pulse signal P1. When the first pulse signal P1 turns on, the pulse signal P12 calculated by the first OR gate 702 as a logical sum turns on (at the timing T61, T65, T69, T73, T77, and T81 in FIG. 15), and the first switch S1 conducts.

When the first switch S1 conducts, a closed circuit comprising an AC power supply 101, an inductor L1, a capacitor C1, and a first switch S1 is formed. As a result, a current I flows from the capacitor C1 to the first switch S1 by the linear action of a reactor of the inductor L1 (in the sections T61-T62, T65-T66, T69-T70, T73-T74, T77-T78, and T81-T82 in GIG. 15).

When the circuit current I reaches a peak value Tp (at the timing T62, T66, T70, T74, T78, and T82 in

FIG. 15), the latch circuit 610 is reset, and the first pulse signal P1 turns off. When the first pulse signal P1 turns off, the pulse signal P12 calculated by the first OR gate 702 as a logical sum turns off. Therefore, the first switch S1 becomes nonconductive.

When the first switch S1 becomes nonconductive, the current flowing through the first switch S1 becomes zero. At this time, the inductor L1 tends to flow a current in the same direction by the energy of a reactor. Thus, a current flows into the smoothing capacitor C2 through the second diode D2 (at the timing T62-T63, T66-T67, T70-T71, T74-T75, T78-T79, and T82-T83 in FIG. 15).

When minute delay time d elapses after the first pulse signal P1 turns off (at the timing T63, T67, T71,

T75, T79, and T83 in FIG. 15), the first delay pulse signal P13 turns on. When the first delay pulse signal P13 turns on, the pulse signal P22 calculation by the second OR gate 703 as a logical sum turns on, and the second switch S2 conducts. When the second switch S2 becomes conductive, the current flowing into the smoothing capacitor C2 through the second diode D2 flows into the smoothing capacitor C2 through the second switch S2 (in the sections T63-T64, T67-T68, T71-T72, T75-T76, T79-T80, and T83-T84 in FIG. 15).

Thereafter, the first delay pulse signal P13 turns off at the timing just before the circuit current I flowing through the second switch S2 becomes zero (at the timing T64, T68, T72, T76, T80, and T84 in FIG. 15). When the first delay pulse signal P13 turns off, the pulse signal P22 calculation by the second OR gate 703 as a logical sum turns off, and the second switch S2 becomes nonconductive. When the second switch S2 becomes nonconductive, the current flowing into the smoothing capacitor C2 through the second switch S2 flows again into the smoothing capacitor C2 through the second diode D2.

FIG. 16 is a timing chart showing the operation of the power conversion apparatus 600 when the polarity of the AC voltage Va is negative. When the polarity of the AC voltage Va is negative, the pulse generator 611 periodically outputs a second pulse signal P2. When the second pulse signal P2 turns on, the pulse signal P22 calculation by the second OR gate 703 as a logical sum turns on (at the timing T91, T95, T99, T103, T107, and T111 in FIG. 16), and the second switch S2 conducts.

When the second switch S2 conducts, a closed circuit comprising an AC power supply 101, an inductor L1, a capacitor C1, a second switch Q2, and a smoothing capacitor C2 is formed. At this time, the voltage of the smoothing capacitor C2 is higher than the AC voltage Va. As a result, the power conversion apparatus 700 operates so that the charging voltage of the smoothing capacitor C2 returns to the AC power supply 101 through the second switch Q2 and inductor L1. As a result, a current flows from the capacitor C2 to the second switch Q2 (in the sections T91-T92, T95-T96, T99-T100, T103-T104, T107-T108, and T111-T112 in FIG. 16).

When the circuit current I reaches a peak value Tp (at the timing T92, T96, T100, T104, T108, and T112 in FIG. 16), the latch circuit 610 is reset, and the second pulse signal P2 turns off. When the second pulse signal P2 turns off, the pulse signal P22 calculation by the second OR gate 703 as a logical sum turns off, and the second switch S2 becomes nonconductive.

When the second switch S1 becomes nonconductive, the current flowing through the second switch S2 becomes zero. At this time, the inductor L1 tends to flow a current in the same direction by the energy of a reactor. Thus, a current flows into the capacitor C1 through the first diode D1 (at the timing T92-T93, T96-T97, T100-T101, T104-T105, T108-T109, and T112-T113 in FIG. 16).

When minute delay time d elapses after the second pulse signal P2 turns off (at the timing T93, T97, T101, T105, T109, and T113 in FIG. 16), the second delay pulse signal P23 turns on. When the second delay pulse signal P23 turns on, the pulse signal P12 calculation by the first OR gate 702 as a logical sum turns on, and the first switch S1 conducts. When the first switch S1 becomes conductive, the current flowing into the capacitor C1 through the first diode D1 flows into the capacitor C1 through the first switch S1 (in the sections T93-T94, T97-T98, T101-T102, T105-T106, T109-T110, and T113-T114 in FIG. 16).

Thereafter, the second delay pulse signal P23 turns off at the timing just before the circuit current I flowing through the first switch S1 becomes zero (at the timing T94, T98, T102, T106, T110, and T114 in FIG. 16). When the second delay pulse signal P23 turns off, the pulse signal P12 calculation by the first OR gate 702 as a logical sum turns off, and the first switch S1 becomes nonconductive. When the first switch S1 becomes nonconductive, the current flowing into the capacitor C1 through the first switch S1 flows again into the capacitor C1 through the first diode D1.

As described above, in the power conversion apparatus 700, the current flowing through the second diode D2 as a result that the first switch S1 becomes nonconductive flows into the second switch S2 after minute delay time d elapses from the timing that the first switch S1 becomes nonconductive. Just before the current becomes zero, a current flows again into the second diode D2. Similarly, the current flowing into the first diode D1 as a result that the second switch S2 becomes nonconductive flows into the first switch S1 after minute delay time d elapses from the timing that the second switch S2 becomes nonconductive. Immediately before the current becomes zero, a current flows again into the first diode D1. Therefore, the power conversion efficiency can be further increased.

As seen from the above description, according to the embodiment, a power conversion apparatus with an increased conversion efficiency can be obtained.

Modifications of the embodiments are explained hereinafter.

The semiconductor switches Q1 and Q2 used in the first, third and fifth embodiments are not limited to a MOSFET. The semiconductor switches Q1 and Q2 may be a semiconductor element having a body diode such as an insulated gate bipolar transistor (IGBT), for example.

The switches S1 and S2 used in the second, fourth and seventh embodiments are not limited to a mechanical switch. The switches S1 and S2 may be a semiconductor switch not having a body diode, such as a triac capable of controlling conduction and nonconduction of current in two directions. In short, any switch able to switch conduction and nonconduction irrespective of a direction of current may be used. In the fourth, sixth and seventh embodiments, a semiconductor switch having a body diode such as an FET may be used.

In the fourth embodiment, the circuit configuration of the AC power supply 101 to the output terminals 102 and 103 is the same as in the power conversion apparatus 200 of the second embodiment. However, this circuit configuration may be the same as in the power conversion apparatus 100 or 300 of the first or third embodiment. In the fifth embodiment, the circuit configuration of the AC power supply 101 to the output terminals 102 and 103 is the same in the power conversion apparatus 300 of the third embodiment. However, this circuit configuration may be the same as in the power conversion apparatus 100 or 200 of the first or second embodiment. Likewise, in the sixth and seventh embodiments, the circuit configuration of the AC power supply 101 to the output terminals 102 and 103 is not limited to those of the embodiments.

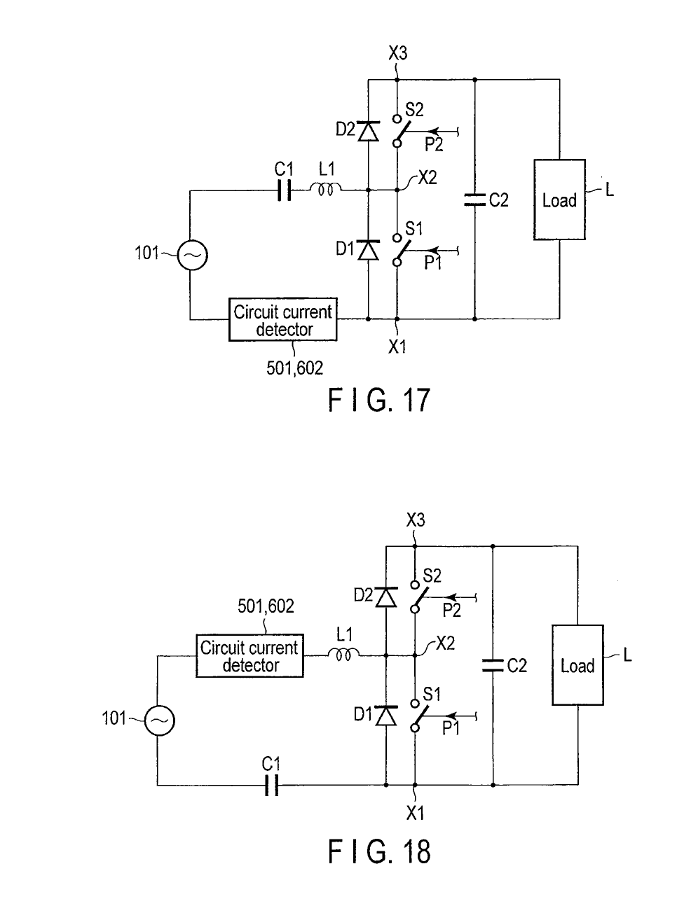

Further, the circuit configuration of the AC power supply 101 to the output terminals 102 and 103 is not limited to those of the first, second and third embodiments. For example, the inductor L1 and capacitor C1 connected to the AC power supply 101 are connected in series. As shown in FIG. 17, it is possible to connect one end of the capacitor C1 to one end of the AC power supply 101, and connect a first switch (the first semiconductor switch Q1 or first mechanical switch S1) to the other end of the capacitor C1 through the inductor 11.

Further, in the fifth, sixth and seventh embodiments, the current I flowing across the AC power supply 101 and the point X1 is detected by the current detectors 501 and 602. However, the position to detect the circuit current I is not limited to those in the above embodiments. For example, a circuit may be configured as shown in FIGS. 18 to 20.

FIG. 18 shows an example in which an inductor L1 is connected to one end of an AC power supply 101 through current detectors 501 and 602, a capacitor C1 is connected to the other end of the AC power supply 101, and a current flowing across the AC power supply 101 and inductor L1 is detected as a circuit current I.

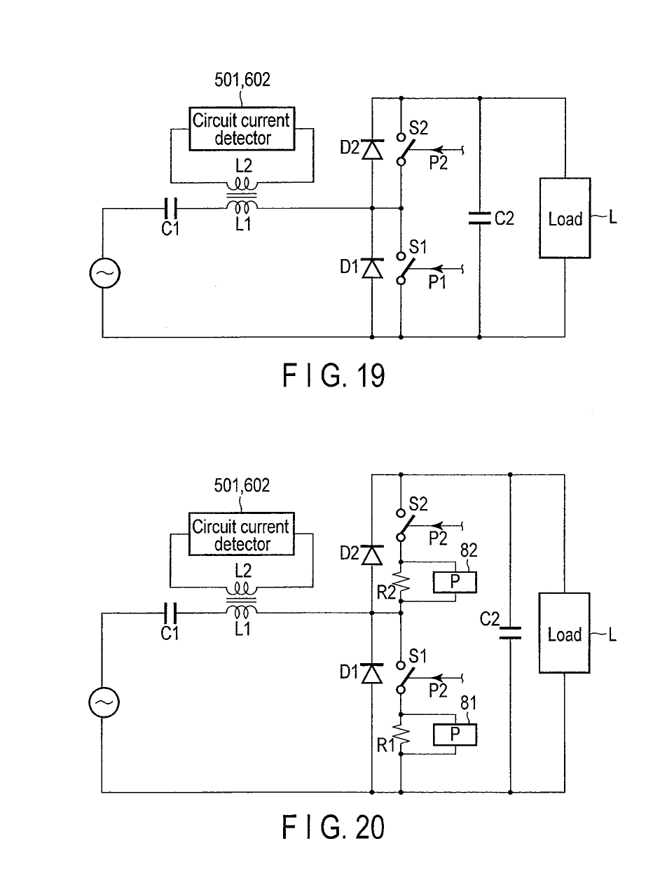

FIG. 19 shows an example in which a secondary winding L2 is placed opposite to an inductor L1, and a circuit current I is detected from the voltage generated in the secondary winding L2.

FIG. 20 shows an example in which low resistors R1 and R2 are connected to first and second switches S1 and S2, peak current detectors 81 and 82 are connected at both ends of the low resistors R1 and R2, and a peak current is detected by converting the current flowing through the low resistors R1 and R2 into a voltage. In this example, the current detectors 501 and 602 detect that a circuit current I becomes zero.

In each embodiment, a 100V commercial power supply (50/60 Hz) is used as an AC power supply. However, an AC power supply is not limited to a 100V commercial power supply. For example, a commercial power supply of 200 to 220V (50/60 Hz) may be used as an input power supply, converted into a desired DC voltage, and then supplied to a load.

For example, in the power conversion apparatus 600 shown in FIG. 11, when a 100V AC power is applied, and power of 200W is supplied to a load, the peak current determinator 607 determines an envelope so that an average current Ia becomes 2 amperes. On the other hand, when a 200V AC power is applied, an envelope is automatically determined so that an average current becomes 1 ampere. This results from the fact that feedback is effected so that an output voltage becomes the same as a reference voltage.

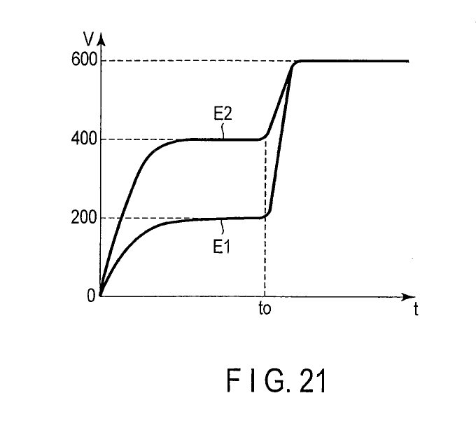

FIG. 21 shows waveforms showing a voltage change at startup, when 100V and 200V AC power are applied. When 100V AC power is applied, a voltage charged in a smoothing capacitor C2 is about 200V as indicated by E1 in FIG. 21. On the other hand, when 200V AC power is supplied, a voltage charged in the smoothing capacitor C2 is about 400V as indicated by E2 in FIG. 21. In either case, when switching is started (at the timing t0), an output voltage is controlled to be equal to a reference voltage (600V in this example).

While certain embodiments have been described, these embodiments have been presented by way of example only, and are not intended to limit the scope of the invention. Indeed, the novel embodiments described herein may be embodied in a variety of other forms; furthermore, various omissions, submissions and changes in the form of the embodiments described herein may be made without departing from the spirit of the invention. The accompanying claims and their equivalents are intended to cover such forms or modifications as would fall within the scope and spirit of the invention.

What is claimed is:

1. A power conversion apparatus comprising:
a first switch connected at both ends of an AC power supply through an inductor and capacitor connected in series;
a second switch connected at both ends of the first switch through a smoothing capacitor connected in series; and
a pulse generator which generates a first pulse signal for driving the first switch at a frequency higher than a cycle of the AC voltage, and supplies the pulse signal to the first switch, when the polarity of the voltage of the AC power supply is positive, and generates a second pulse signal for driving the second switch at a frequency higher than a cycle of the AC voltage, and supplies the pulse signal to the second switch, when the polarity of the voltage of the AC power supply is negative.

2. The apparatus of claim 1, wherein the first and second switches are semiconductor switches having a body diode.

3. The apparatus of claim 1, wherein the first and second switches are mechanical switches or semiconductor switches not having a body diode, and a diode is externally added parallel to the first and second switches.

4. The apparatus of claim 3, further comprising a circuit current detector, which detects a circuit current flowing through the AC power supply, and sends a detected value to the pulse generator,
wherein the pulse generator generates a third pulse signal for conducting the second switch for a predetermined time that the first pulse signal turns off and turns on again while the circuit current is flowing, and supplies the pulse signal to the second switch, when the polarity of the voltage of the AC power supply is positive, and generates a fourth pulse signal for conducting the first switch for a predetermined time that the second pulse signal turns off and turns on again while the circuit current is flowing, and supplies the pulse signal to the first switch, when the polarity of the voltage of the AC power supply is negative.

5. The apparatus of claim 1, wherein the first and second switches are semiconductor switches having a body diode, and
a diode having a forward voltage lower than the body diode is externally added parallel to the first and second switches.

6. The apparatus of claim 5, further comprising a circuit current detector, which detects a circuit current flowing through the AC power supply, and sends a detected value to the pulse generator,
wherein the pulse generator generates a third pulse signal for conducting the second switch for a predetermined time that the first pulse signal turns off and turns on again while the circuit current is flowing, and supplies the pulse signal to the second switch, when the polarity of the voltage of the AC power supply is positive, and generates a fourth pulse signal for conducting the first switch for a predetermined time that the second pulse signal turns off and turns on again while the circuit current is flowing, and supplies the pulse signal to the first switch, when the polarity of the voltage of the AC power supply is negative.

7. The apparatus of claim 1, further comprising an output voltage detector which detects voltages at both ends of the smoothing capacitor, and sends a detected value to the pulse generator,
wherein the pulse generator reduces the width of the first or second pulse signal when the voltage detected by the output voltage detector is higher than a predetermined voltage, and extends the width of the first or second pulse signal when the voltage is lower than the predetermined voltage.

8. The apparatus of claim 1, further comprising:
a circuit current detector which detects a circuit current flowing through the AC power supply, and sends a detected value to the pulse generator;
an input voltage detector which detects a voltage of the AC power supply;
an output voltage detector which detects voltages at both ends of the smoothing capacitor, and sends detected values to the pulse generator;
a comparator which calculates a difference value between the output voltage detected by the output voltage detector and a predetermined set value;
a peak current determinator which calculates a product of the input voltage detected by the input voltage detector and the voltage difference value calculated by the comparator, as a peak value;
a latch circuit which supplies a signal to the pulse generator over the time that a signal is applied to a set terminal and then applied to a reset terminal;
a current zero determinator which supplies a signal to the set terminal of the latch circuit when a current value detected by the circuit current detector becomes zero; and
a current peak determinator which supplies a signal to the reset terminal of the latch circuit when a current value detected by the circuit current detector reaches a peak value calculated by the peak current determinator,
wherein the pulse generator controls the width of the first or second pulse signal for the duration that the output of the latch circuit is being input.

9. The apparatus of claim 8, wherein the first and second switch are mechanical switches or semiconductor switches not having a body diode, and
a diode is externally added parallel to the first and second switches.

10. The apparatus of claim 9, further comprising:
a sub-pulse generator, which is supplied with an input voltage detected by the input voltage detector, a circuit current detected by the circuit current detector, and a signal output from the latch circuit, and when the polarity of the input voltage is positive, supplies a second sub-pulse signal to the second switch for turning on the second switch over the time that the signal output from the latch circuit is reset, a predetermined time elapses, and the circuit current becomes just before zero; and when the polarity of the input voltage is negative, supplies a first sub-pulse signal to the first switch for turning on the first switch over the time that the signal output from the latch circuit is reset, a predetermined time elapses, and the circuit current becomes just before zero.

11. The apparatus of claim 8, wherein the first and second switches are semiconductor switches having a body diode, and
a diode having a forward voltage lower than the body diode is externally added parallel to the first and second switches.

12. The apparatus of claim 11, further comprising:
a sub-pulse generator, which is supplied with an input voltage detected by the input voltage detector, a circuit current detected by the circuit current detector, and a signal output from the latch circuit, and when the polarity of the input voltage is positive, supplies a second sub-pulse signal to the second switch for turning on the second switch over the time that the signal output from the latch circuit is reset, a predetermined time elapses, and the circuit current becomes just before zero; and when the polarity of the input voltage is negative, supplies a first sub-pulse signal to the first switch for turning on the first switch over the time that the signal output from the latch circuit is reset, a predetermined time elapses, and the circuit current becomes just before zero.

13. A power conversion method comprising:
connecting a first switch at both ends of an AC power supply through an inductor and capacitor connected in series; and
connecting a second switch connected at both ends of the first switch through a smoothing capacitor connected in series
wherein when the polarity of the voltage of the AC power supply is positive, a pulse generator generates a first pulse signal for driving the first switch at a frequency higher than a cycle of the AC voltage, and
when the polarity of the voltage of the AC power supply is negative, the pulse generator generates a second pulse signal for driving the second switch at a frequency higher than a cycle of the AC voltage, and supplies the pulse signal to the second switch.

14. The method of claim 13, wherein the first and second switches are semiconductor switches having a body diode.

15. The method of claim 13, wherein the first and second switches are mechanical switches or semiconductor switches not having a body diode, and
a diode is externally added parallel to the first and second switches.

16. The method of claim 15, wherein a circuit current detector detects a circuit current flowing through the AC power supply, and sends a detected value to the pulse generator, and
the pulse generator generates a third pulse signal for conducting the second switch for a predetermined time that the first pulse signal turns off and turns on again while the circuit current is flowing, and supplies the pulse signal to the second switch, when the polarity of the voltage of the AC power supply is positive; and generates a fourth pulse signal for conducting the first switch for a predetermined time that the second pulse signal turns off and turns on again while the circuit current is flowing, and supplies the pulse signal to the first switch, when the polarity of the voltage of the AC power supply is negative.

17. The method of claim 13, wherein the first and second switches are semiconductor switches having a body diode, and
a diode having a forward voltage lower than the body diode is externally added parallel to the first and second switches.

18. The method of claim 17, wherein a circuit current detector detects a circuit current flowing through the AC power supply, and sends a detected value to the pulse generator, and
the pulse generator generates a third pulse signal for conducting the second switch for a predetermined time that the first pulse signal turns off and turns on again while the circuit current is flowing, and supplies the pulse signal to the second switch, when the polarity of the voltage of the AC power supply is positive; and generates a fourth pulse signal for conducting the first switch for a predetermined time that the second pulse signal turns off and turns on again while the circuit current is flowing, and supplies the pulse signal to the first switch, when the polarity of the voltage of the AC power supply is negative.

19. The method of claim 13, wherein an output voltage detector detects voltages at both ends of the smoothing capacitor, and sends detected values to the pulse generator, and
the pulse generator reduces the width of the first or second pulse signal when the voltage detected by the output voltage detector is higher than a predetermined voltage, and extends the width of the first or second pulse signal when the voltage is lower than the predetermined voltage.
